(19) United States
(12) Patent Application Publication
(10) Pub. No.: US 2024/0410528 A1
(43) Pub. Date: Dec. 12, 2024

(54) HYDROGEN TANK STRUCTURE

(71) Applicant: TOYOTA JIDOSHA KABUSHIKI KAISHA, Toyota-shi (JP)

(72) Inventors: Chihiro UCHIMURA, Toyota-shi (JP); Chiaki KATAOKA, Nagakute-shi (JP)

(73) Assignee: TOYOTA JIDOSHA KABUSHIKI KAISHA, Toyota-shi (JP)

(21) Appl. No.: 18/581,714

(22) Filed: Feb. 20, 2024

(30) Foreign Application Priority Data
Jun. 8, 2023 (JP) 2023-094473

(51) Int. Cl. F17C 11/00

(52) U.S. Cl. CPC F17C 11/005; F17C 2221/012; F17C 2223/0123

(57) ABSTRACT

The hydrogen tank structure includes a plurality of hydrogen tanks arranged in parallel and an elongated manifold connected to one end of each hydrogen tank. The manifold has a hydrogen gas channel extending along the longitudinal direction of the manifold in the interior of the manifold and communicating with the interior of each hydrogen tank, and a heat insulating portion provided in the vicinity of the hydrogen gas channel.

### CROSS-REFERENCE TO RELATED APPLICATION

This application claims priority to Japanese Patent Application No. 2023-094473 filed on Jun. 8, 2023, incorporated herein by reference in its entirety.

### BACKGROUND

### 1. Technical Field

The present disclosure relates to a hydrogen tank structure.

### 2. Description of Related Art

Hitherto, a technology described in, for example, Japanese Unexamined Patent Application Publication No. 2019-32034 (JP 2019-32034 A) is provided as such a technical field. A hydrogen tank structure described in JP 2019-32034 A includes a plurality of small hydrogen tanks arranged in parallel, and a manifold for fixing the hydrogen tanks and filling the tanks with hydrogen gas. A hydrogen gas channel is provided inside the manifold. The hydrogen tanks are filled with cooled hydrogen gas through the hydrogen gas channel.

### SUMMARY

In the above hydrogen tank structure, however, the manifold is made of metal and the thermal mass (that is, the heat capacity) of the manifold is large. Therefore, the cooled hydrogen gas receives heat from the manifold when passing through the hydrogen gas channel inside the manifold. Thus, the temperature rises. When the temperature rises, the amount of hydrogen charged into the tank decreases. A problem arises in that the tank does not become full. In order to solve this problem, it is considered to reduce the size of the manifold so as to reduce the thermal mass. However, a problem newly arises in that the drop resistance performance of the manifold decreases.

The present disclosure has been made to solve such a technical problem, and an object of the present disclosure is to provide a hydrogen tank structure that can suppress heat transfer from a manifold to a hydrogen gas channel and prevent a temperature rise of charged hydrogen gas.

A hydrogen tank structure according to the present disclosure is a hydrogen tank structure including a plurality of hydrogen tanks arranged in parallel, and an elongated manifold connected to one end of each of the hydrogen tanks. The manifold includes: a hydrogen gas channel extending along a longitudinal direction of the manifold inside the manifold and communicating with interiors of the hydrogen tanks; and a heat insulating portion provided near the hydrogen gas channel.

In the hydrogen tank structure according to the present disclosure, the heat insulating portion provided near the hydrogen gas channel serves to suppress heat transfer from the manifold to the hydrogen gas channel, and can therefore suppress the temperature rise of hydrogen gas flowing through the hydrogen gas channel. As a result, it is possible to reduce heat reception from the manifold at the time of charging hydrogen gas, and to prevent the temperature rise of the charged hydrogen gas. As a result, it is possible to suppress a decrease in the amount of charged hydrogen due to the temperature rise.

In the hydrogen tank structure according to the present disclosure, the heat insulating portion may be a cavity portion provided inside the manifold and extending along the longitudinal direction of the manifold, and when viewed in the longitudinal direction of the manifold, the cavity portion may have a C-shape in cross section to surround the hydrogen gas channel, and the C-shape may be open to the hydrogen tanks. With this configuration, the heat insulating portion suppresses heat transfer from the manifold to the hydrogen gas channel. Therefore, it is possible to reduce heat reception from the manifold, and to prevent the temperature rise of the charged hydrogen gas.

In the hydrogen tank structure according to the present disclosure, the manifold may further include a manifold body provided with the hydrogen gas channel, and the heat insulating portion may be a heat insulating material disposed on an outer periphery of the manifold body to surround the manifold body. In this case, heat transfer from an external environment to the manifold body is blocked by using the heat insulating material disposed on the outer periphery of the manifold body. Therefore, influence of the outside air temperature on the manifold body can be reduced. As a result, it is possible to suppress heat transfer from the manifold to the hydrogen gas channel, and to prevent the temperature rise of the charged hydrogen gas.

In the hydrogen tank structure according to the present disclosure, the heat insulating portion may be a heat insulating coating provided on an inner wall surface of the hydrogen gas channel. In this case, it is possible to suppress heat transfer from the manifold to the hydrogen gas channel by using the heat insulating coating, and to prevent the temperature rise of the charged hydrogen gas.

In the hydrogen tank structure according to the present disclosure, the heat insulating portion may be a gas circulation path communicating with the hydrogen gas channel and configured to circulate hydrogen gas inside the manifold. In this case, it is possible to suppress heat transfer from the manifold to the hydrogen gas channel by using the gas circulation path, and to prevent the temperature rise of the charged hydrogen gas. In addition, it is possible to reduce the occurrence of a case where the temperature of the charged hydrogen gas becomes uneven.

According to the present disclosure, it is possible to suppress heat transfer from the manifold to the hydrogen gas channel, and to prevent the temperature rise of the charged hydrogen gas.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view showing a hydrogen tank structure according to a first embodiment;

FIG. 2A is a cross-sectional view taken along I-I line of FIG. 1;

FIG. 2B is a cross-sectional view taken along II-II line of FIG. 1;

FIG. 3 is a cross-sectional view showing a hydrogen tank structure according to a second embodiment;

FIG. 4 is a cross-sectional view showing a hydrogen tank structure according to a third embodiment;

FIG. 5 is a schematic cross-sectional view showing a hydrogen tank structure according to a fourth embodiment;

FIG. 6A is a cross-sectional view taken along V-V line of FIG. 5; and

FIG. 6B is a sectional view taken along VI-VI of FIG. 5.

### DETAILED DESCRIPTION OF EMBODIMENTS

Hereinafter, an embodiment of a tank holding structure according to the present disclosure will be described with reference to the drawings. In the description of the drawings, the same elements are denoted by the same reference numerals, and redundant description thereof will be omitted.

### First Embodiment

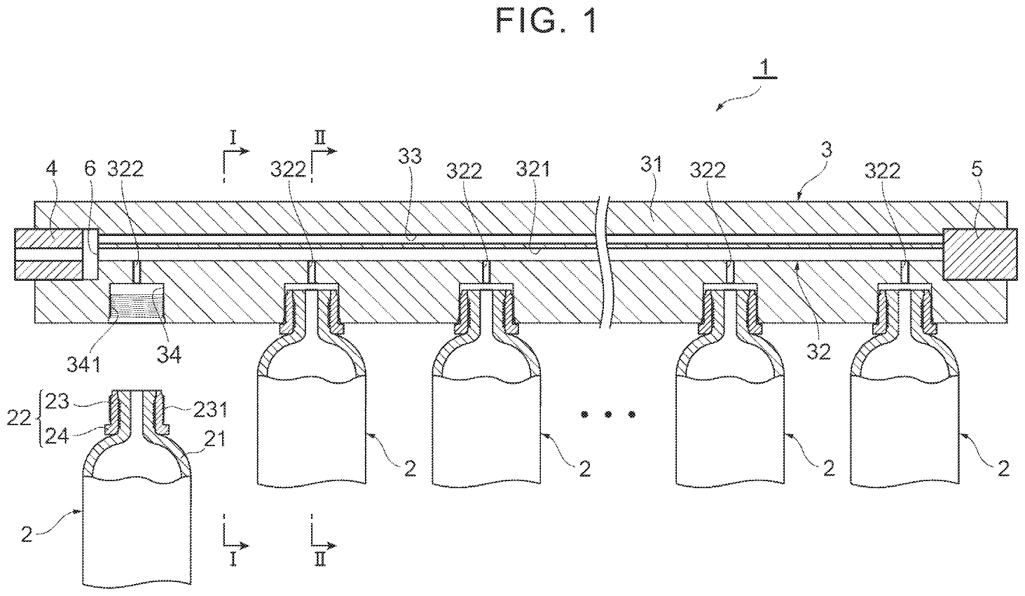

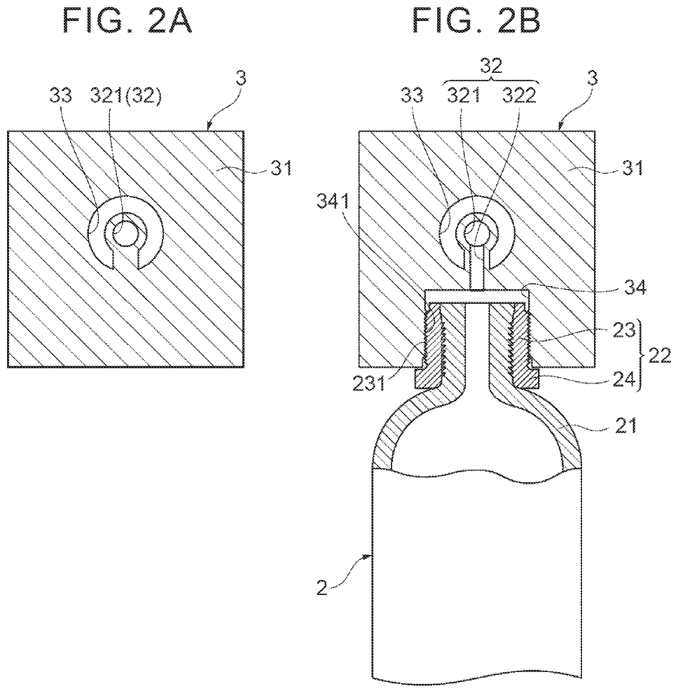

FIG. 1 is a schematic cross-sectional view showing a hydrogen tank structure according to a first embodiment. FIGS. 2A and 2B are cross-sectional views taken along I-I and II-II lines in FIG. 1. In FIG. 1, in order to make the structure of the receiving recess 34 (described later) of the manifold 3 easy to understand, a state before the hydrogen tank 2 is inserted into the receiving recess 34 is shown.

The hydrogen tank structure 1 of the present embodiment is mounted on, for example, a fuel cell electric vehicle (not shown). The hydrogen tank structure 1 includes a plurality of hydrogen tanks 2 arranged in parallel, and an elongated manifold 3 connected to one end of each hydrogen tank 2.

The hydrogen tank 2 is also referred to as a chamber, and is a small-diameter tank in which the opening of the tank is reduced. The hydrogen tank 2 is a high-pressure container having a space in which hydrogen gas is stored. The hydrogen tank 2 includes a tank main body 21 having a substantially cylindrical shape, and a base portion 22 attached to an open end portion of the tank main body 21. Although not shown, the tank main body 21 includes a substantially cylindrical liner having both ends rounded in a dome shape, and a fiber-reinforced resin layer covering the outer peripheral surface of the liner. The liner may be made of aluminum or resin.

The base portion 22 is formed into a cylindrical shape by a metal material such as stainless steel or an aluminum alloy. The base portion 22 has a cylindrical base body 23 extending along the axial direction of the hydrogen tank 2, and a flange portion 24 connected to one end portion of the base body 23 and protruding in the radial direction. The base portion 22 is fixed to the open end portion of the tank main body 21 by screwing in a state of being extrapolated to the open end portion.

Further, the outer peripheral wall of the base body 23, the male screw portion 231 is threadedly engaged with the female screw portion 341 formed in the receiving recess 34 of the manifold 3 is formed. The flange portion 24 has a function of increasing the strength of the entire base portion 22 and a function of regulating the depth of screwing when screwing with the manifold 3, and is integrally formed with the base body 23.

As shown in FIG. 1, the plurality of hydrogen tanks 2 having such a structure are arranged side by side in one direction. Each hydrogen tank 2 is connected to the manifold 3 by screwing the male screw portion 231 and the female screw portion 341 of the receiving recess 34 in a state of being inserted into the receiving recess 34 of the manifold 3.

The manifold 3 is a metal member that performs a function of fixing the plurality of hydrogen tanks 2 and a function of filling the inside of each hydrogen tank 2 with hydrogen gas. In the present embodiment, the manifold 3 is formed of, for example, an aluminum extruded material.

The manifold 3 includes an elongated manifold body 31 having a rectangular cross section, a hydrogen gas channel 32 provided inside the manifold body 31, and a heat insulating portion 33 provided in the vicinity of the hydrogen gas channel 32.

The manifold body 31 is provided with a plurality of receiving recesses 34 for receiving the base portion 22 of the hydrogen tank 2. As shown in FIG. 1, the plurality of receiving recesses 34 are arranged at equal intervals along the longitudinal direction of the manifold body 31, and are located on the same side (the hydrogen tank 2 side) of the manifold body 31. The receiving recess 34 is formed of a cylindrical cavity and opens toward the hydrogen tank 2. A female screw portion 341 for screwing with the male screw portion 231 of the base portion 22 of the hydrogen tank 2 is formed on the inner peripheral wall of the receiving recess 34.

The hydrogen gas channel 32 is disposed at a substantially central position of the manifold body 31. The hydrogen gas channel 32 has a main flow path 321 extending along the longitudinal direction of the manifold body 31, and a plurality of sub flow paths 322 branching from the main flow path 321 and communicating the main flow path 321 and the receiving recess 34. The main flow path 321 has a circular cross section. One longitudinal end of the main flow path 321 is connected to In/Out connection 4, and the other end is closed by an end plug 5. The sub flow path 322 is provided in a one-to-one manner with respect to the plurality of receiving recesses 34. The sub flow path 322 is positioned coaxially with the opening of the tank main body 21 inserted into the receiving recess 34.

The hydrogen gas channel 32 is connected to a bulb (not shown) attached to the manifold 3 via In/Out connection 4. When the hydrogen is charged, the hydrogen gas supplied from the hydrogen station flows into the main flow path 321 through the bulb and In/Out connection 4 in a cooled state (for example, −40° C.), and further flows into the hydrogen tank 2 through the sub flow path 322.

The heat insulating portion 33 includes a cavity portion extending along the longitudinal direction of the manifold body 31 inside the manifold body 31. As shown in FIGS. 2A and 2B, when viewed from the longitudinal direction of the manifold body 31, the heat insulating portion 33 (i.e., the cavity portion) is formed in a C-shaped cross section so as to surround the hydrogen gas channel 32, the opening of the C-shape faces the hydrogen tank 2 side.

As shown in FIG. 1, one longitudinal end of the heat insulating portion 33 is closed by an In/Out connection 4, and the other end is closed by an end plug 5. Then, on In/Out connection 4 side, the heat insulating portion 33 communicates with the hydrogen gas channel 32 via the communication passage 6. During hydrogen filling, the hydrogen gas flows into the inside of the heat insulating portion 33 (i.e., the cavity portion) via the communication passage 6, but the other end of the heat insulating portion 33 is blocked by the end plug 5, so that the flow of the hydrogen gas is not generated.

As shown in FIGS. 2A and 2B, the main flow path 321 of the hydrogen gas channel 32 is disposed inside the heat insulating portion 33 having a C-shaped cross section. On the other hand, the sub flow path 322 of the hydrogen gas channel 32 passes through the opening of the C-shaped heat insulating portion 33 and communicates the main flow path 321 with the receiving recess 34.

In the hydrogen tank structure 1 according to the present embodiment, since the heat insulating portion 33 communicates with the hydrogen gas channel 32 through the communication passage 6, the pressure of the heat insulating portion 33 and the pressure of the hydrogen gas channel 32 are the same. Further, since the heat insulating portion 33 has a C-shaped cross section and surrounds the main flow path 321 of the hydrogen gas channel 32, heat transfer from the manifold 3 to the main flow path 321 of the hydrogen gas channel 32 can be suppressed, and heat reception from the manifold 3 can be reduced. Therefore, it is possible to prevent an increase in the temperature of the charged hydrogen gas at the time of hydrogen filling, and it is possible to suppress a decrease in the hydrogen filling amount due to an increase in the temperature. Further, since it is not necessary to reduce the size of the manifold 3 in this manner, the drop resistance performance of the manifold 3 is not affected. As a result, the heat reception from the manifold 3 can be reduced without deteriorating the drop resistance performance.

### Second Embodiment

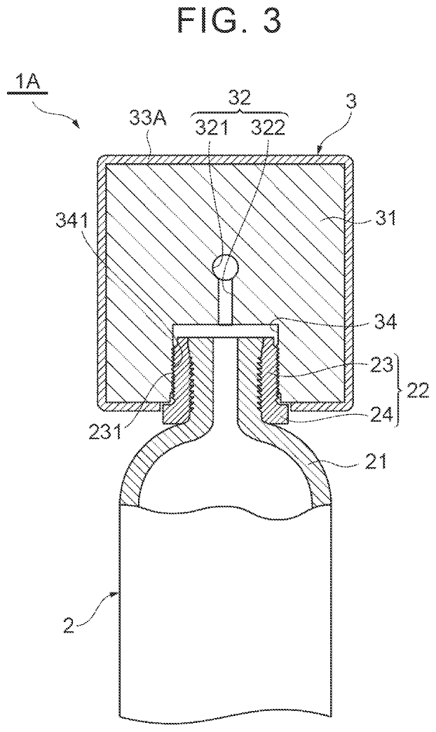

Hereinafter, a second embodiment of a hydrogen tank structure will be described with reference to FIG. 3. The hydrogen tank structure 1A of the present embodiment is different from the first embodiment described above in the structure of the heat insulating portion. The other structures are the same as those of the first embodiment, and thus redundant descriptions thereof will be omitted.

As shown in FIG. 3, the heat insulating portion 33A of the present embodiment is a heat insulating material disposed on the outer periphery of the manifold body 31 so as to surround the manifold body 31. More specifically, the heat insulating portion 33A is formed in a square cylindrical shape by winding a sheet-shaped heat insulating material around the outer peripheral surface of the manifold body 31. The heat insulating material is in close contact with the outer peripheral surface of the manifold body 31 with, for example, an adhesive or the like. Note that the heat insulating portion 33A is not provided at the location where the receiving recess 34 is formed so as not to interfere with the inserting of the hydrogen tank 2.

The heat insulating material may be, for example, a synthetic resin foam or a fiber heat insulating material. As the synthetic resin foam, a foam having closed cells such as polyethylene, polypropylene, polystyrene, polyurethane, or phenolic resin can be used. As the fiber heat insulating material, glass fiber, polyester, nylon nonwoven fabric, cellulose fiber, or the like can be used.

According to the hydrogen tank structure 1A of the present embodiment, the heat transfer from the external environment to the manifold body 31 is blocked by using the heat insulating material disposed on the outer periphery of the manifold body 31, whereby the effect of the outside air temperature on the manifold body 31 can be reduced. As a result, heat transfer from the manifold 3 to the hydrogen gas channel 32 can be suppressed, and heat reception from the manifold 3 can be reduced. Therefore, it is possible to prevent an increase in the temperature of the charged hydrogen gas at the time of hydrogen filling, and it is possible to suppress a decrease in the hydrogen filling amount due to an increase in the temperature. Further, since the heat insulating material is disposed on the outer periphery of the manifold body 31 so as to surround the manifold body 31, it is also possible to perform a cushioning function of protecting the manifold body 31, it is possible to improve the drop resistance performance of the manifold 3.

### Third Embodiment

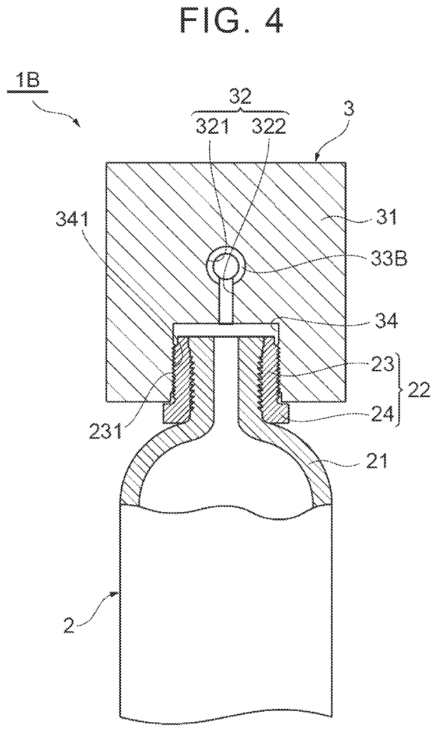

Hereinafter, a third embodiment of a hydrogen tank structure will be described with reference to FIG. 4. The hydrogen tank structure 1B of the present embodiment is different from the first embodiment described above in the structure of the heat insulating portion. The other structures are the same as those of the first embodiment, and thus redundant descriptions thereof will be omitted.

As shown in FIG. 4, the heat insulating portion 33B of the present embodiment is a heat insulating coating provided on the inner wall surface of the hydrogen gas channel 32. More specifically, a heat insulating coating having a lower thermal conductivity than that of the manifold body 31 is formed on the entire inner wall surface of the main flow path 321 of the hydrogen gas channel 32. The heat insulating coating may be formed by spraying the inner wall surface of the main flow path 321 by thermal spraying while melting, for example, alloy powder or the like. The heat insulating coating may be formed by thermally spraying a ceramic material onto the inner wall surface of the main flow path 321. Alternatively, the heat insulating coating may be formed by spray coating the inner wall surface of the main flow path 321 with a heat insulating paint.

In the present embodiment, the heat insulating coating surrounding the sub flow path 322 is not provided, but a heat insulating coating for taking in the sub flow path 322 may be further provided as necessary. That is, the heat insulating portion 33B may have not only a heat insulating coating surrounding the main flow path 321 but also a heat insulating coating surrounding the sub flow paths 322.

According to the hydrogen tank structure 1B of the present embodiment, since the heat insulating coating having lower thermal conductivity than the manifold body 31 is formed on the entire inner wall surface of the main flow path 321 of the hydrogen gas channel 32, heat transfer from the manifold 3 to the main flow path 321 of the hydrogen gas channel 32 is suppressed by using the heat insulating coating, and heat reception from the manifold 3 can be reduced. Therefore, it is possible to prevent an increase in the temperature of the charged hydrogen gas at the time of hydrogen filling, and it is possible to suppress a decrease in the hydrogen filling amount due to an increase in the temperature. Further, since it is not necessary to reduce the size of the manifold 3 in this manner, the drop resistance performance of the manifold 3 is not affected. As a result, the heat reception from the manifold 3 can be reduced without deteriorating the drop resistance performance.

### Fourth Embodiment

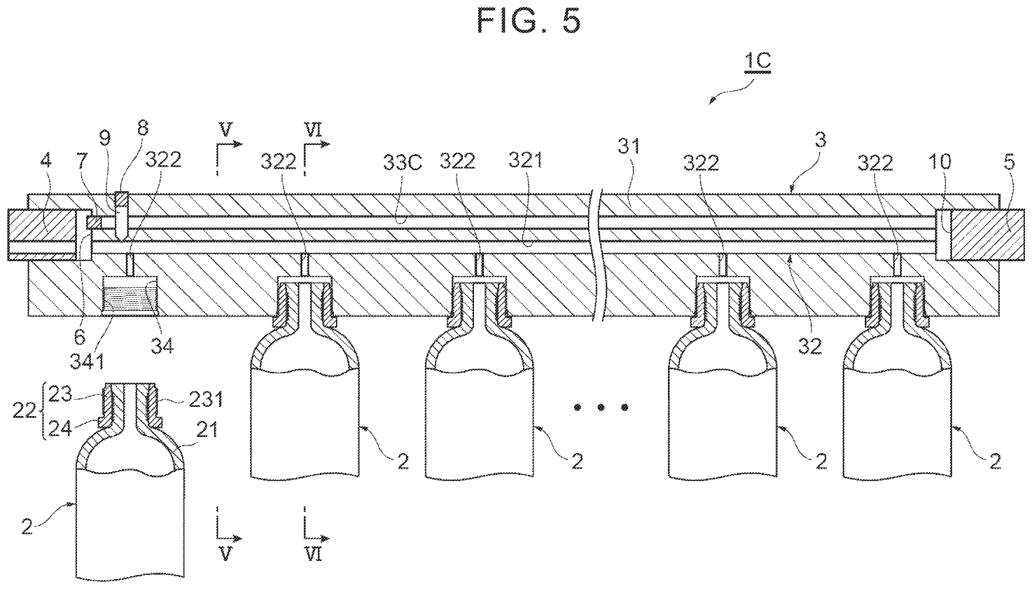

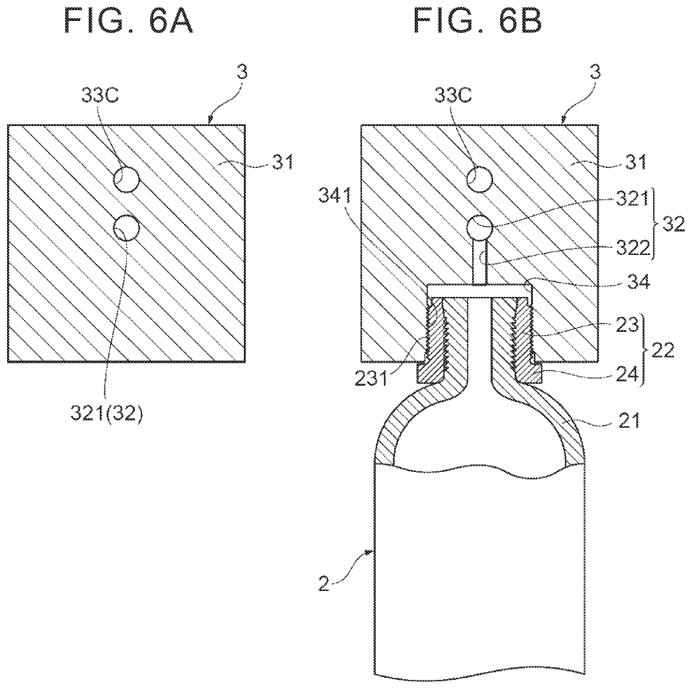

Referring to FIGS. 5, 6A, and 6B, a fourth embodiment of a hydrogen tank structure will be described below. The hydrogen tank structure 1C of the present embodiment is different from the first embodiment described above in the structure of the heat insulating portion. The other structures are the same as those of the first embodiment, and thus redundant descriptions thereof will be omitted.

As illustrated in FIG. 5, the heat insulating portion 33C of the present embodiment is a gas circulation path that communicates with the hydrogen gas channel 32 and circulates the hydrogen gas inside the manifold 3. More specifically, the heat insulating portion 33C is located inside the manifold body 31 and opposite to the hydrogen tank 2 with respect to the hydrogen gas channel 32. The heat insulating portion 33C extends along the longitudinal direction of the manifold body 31 so as to be parallel to the main flow path 321. The heat insulating portion 33C has a circular cross section (see FIGS. 6A and 6B).

In addition, one longitudinal end portion of the heat insulating portion 33C (more specifically, an end portion close to In/Out connection 4) is closed by the plug-7. Further, a venturi tube 9 for generating a negative pressure is provided at the one end. The venturi tube 9 is disposed inside the manifold body 31 so as to communicate the heat insulating portion 33C with the main flow path 321 of the hydrogen gas channel 32, and the open end thereof is closed by the plug 8.

On the other hand, the other end portion of the heat insulating portion 33C in the longitudinal direction is closed by the end plug 5. At the other end, the heat insulating portion 33C communicates with the main flow path 321 of the hydrogen gas channel 32 via the communication passage 10.

According to the hydrogen tank structure 1C of the present embodiment, the heat transfer from the manifold 3 to the main flow path 321 of the hydrogen gas channel 32 can be suppressed by using the gas circulation path constituting the heat insulating portion 33C, and the temperature rise of the filled hydrogen gas can be prevented. Further, since it is not necessary to reduce the size of the manifold 3, the drop resistance performance of the manifold 3 is not affected.

Further, according to the hydrogen tank structure 1C of the present embodiment, it is possible to suppress the temperature-non-uniformity of the charged hydrogen gas. Hereinafter, it will be described in detail.

Among the plurality of hydrogen tanks 2 arranged in parallel, the hydrogen tank 2 arranged at a position closest to In/Out connection 4 receives the least heat from the manifold 3. Then, as the temperature moves away from In/Out connection 4, the heat receiving period of the cooled hydrogen gas from the manifold 3 becomes longer, so that the heat receiving from the manifold 3 also becomes larger. Therefore, the hydrogen gas flowing to the hydrogen tank 2 located farthest from In/Out connection 4 has the highest temperature. In other words, the temperature of the hydrogen-filled gas becomes uneven due to the distance from In/Out connection 4.

In the present embodiment, the main flow path 321, the communication passage 10, the heat insulating portion 33C (i.e., the gas circulation path), and the venturi tube 9 of the hydrogen gas channel 32 form a circuit for circulating the filled hydrogen gas inside the manifold body 31. Due to the negative pressure of the venturi tube 9, a portion of the cooled hydrogen gas circulates along the main flow path 321, the communication passage 10, the heat insulating portion 33C, and the venturi tube 9, so that the temperature of the filled hydrogen gas can be made uniform. As a result, it is possible to suppress the temperature non-uniformity of the charged hydrogen gas.

Although the embodiment of the disclosure has been described in detail above, the disclosure is not limited to the embodiment described above, and various design changes can be made without departing from the spirit of the disclosure described in the claims.

What is claimed is:

1. A hydrogen tank structure comprising a plurality of hydrogen tanks arranged in parallel, and an elongated manifold connected to one end of each of the hydrogen tanks, wherein the manifold includes:
a hydrogen gas channel extending along a longitudinal direction of the manifold inside the manifold and communicating with interiors of the hydrogen tanks; and
a heat insulating portion provided near the hydrogen gas channel.

2. The hydrogen tank structure according to claim 1, wherein:
the heat insulating portion is a cavity portion provided inside the manifold and extending along the longitudinal direction of the manifold; and
when viewed in the longitudinal direction of the manifold, the cavity portion has a C-shape in cross section to surround the hydrogen gas channel, and the C-shape is open to the hydrogen tanks.

3. The hydrogen tank structure according to claim 1, wherein:
the manifold further includes a manifold body provided with the hydrogen gas channel; and
the heat insulating portion is a heat insulating material disposed on an outer periphery of the manifold body to surround the manifold body.

4. The hydrogen tank structure according to claim 1, wherein the heat insulating portion is a heat insulating coating provided on an inner wall surface of the hydrogen gas channel.

5. The hydrogen tank structure according to claim 1, wherein the heat insulating portion is a gas circulation path communicating with the hydrogen gas channel and configured to circulate hydrogen gas inside the manifold.
